(19) United States
(12) Patent Application Publication
(10) Pub. No.: US 2001/0015304 A1
(43) Pub. Date: Aug. 23, 2001

(54) Ladder

(76) Inventor: Anthony James Patrick Hobbs, Wargrave (GB)

Correspondence Address: Charles D. Gunter, Jr., Felsman, Bradley, Vaden, Gunter & Dillon, LLP, Suite 1600, 201 Main Street, Fort Worth, TX, 76102, US

(21) Appl. No.: 09/729,990

(22) Filed: Dec. 5, 2000

Related U.S. Application Data
(63) Continuation of application No. PCT/GB99/01300, filed on Apr. 26, 1999.

(30) Foreign Application Priority Data
Jun. 19, 1998 (GB) 9813170.9

(51) Int. Cl. E06C 1/52

(52) U.S. Cl. 182/195; 182/198

(57) ABSTRACT

There is disclosed a ladder with side supports or stiles of flexible textile material and spaced rung members enclosed in tubular sleeves whose opposed ends are secured to the stiles.

This invention concerns a ladder and, more particularly, a ladder of the kind (hereinafter termed of the kind referred to) generally known as a “rope-ladder” whose rungs extend between supports or stiles which are flexible enabling the ladder to be stowed in a confined space.

Such ladders have many applications and are used for escape, rescue work, inspection work, climbing and sailing for example. Generally though they are quite heavy which limits the length that can conveniently be carried by, for example, a mountaineer or that can be fired to a desired location as a projectile in, for example, rescue work.

It is an object of the present invention to provide a ladder of the kind referred to which is of exceptionally light weight. This objective is achieved by a combination of the choice of materials from which the ladder is made and its method of construction.

According to the present invention, there is provided a ladder comprising side supports or stiles of flexible textile material and rung members enclosed in a tubular sheath whose opposed ends are secured to the stiles.

The stiles may be of synthetic fibre webbing.

The stiles may have a width of about 2 cm.

The rungs may be lengths of carbon fibre rod or tube.

The rungs may have a diameter of about 1 cm and a length of about 15 cm.

The tubular sheath may be a braid of synthetic fibre.

The length of each sheath may be about 22 cm leaving about 3.5 cm at each end for attachment to the stiles.

The attachment may be by sewing.

The invention will be further apparent from the following description with reference to the figures of the accompanying drawing which show, by way of example only, one form of ladder embodying same.

Of the drawings:

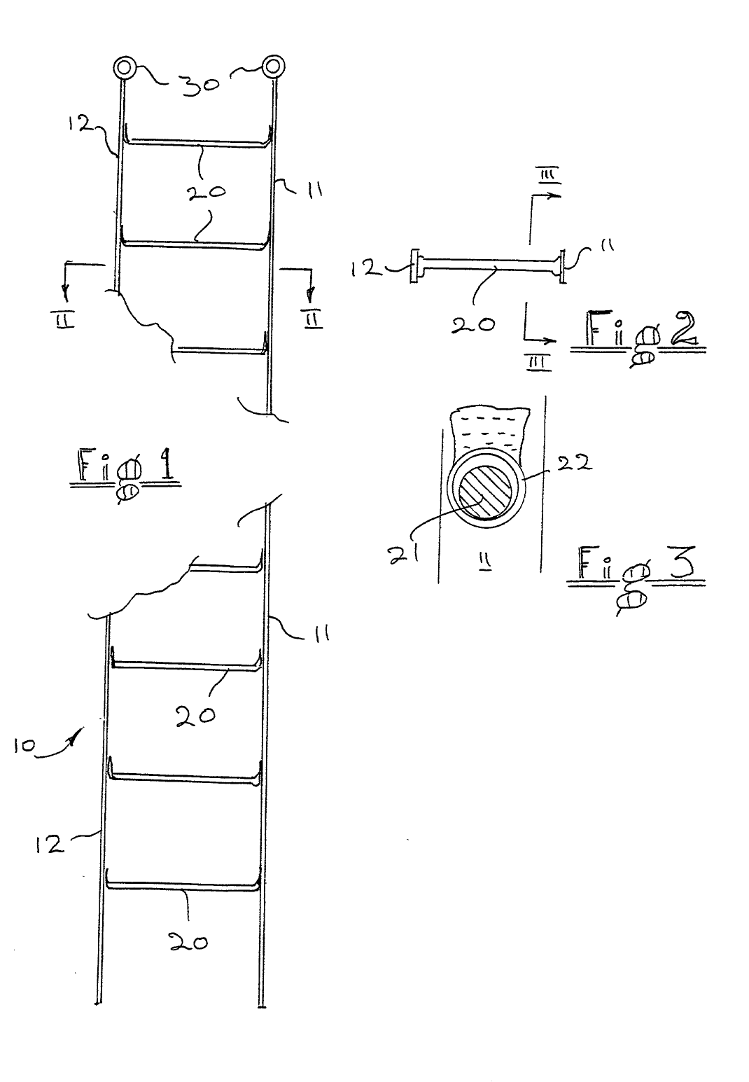

FIG. 1 shows a front elevation of the ladder;

FIG. 2 shows a cross-section through the ladder on the line II-II of FIG. 1; and

FIG. 3 shows a fragmentary cross-section through the ladder on an enlarged scale on the line III-III of FIG. 2.

Referring now to the drawing, it will be seen that the ladder generally indicated at 10 comprises opposed side supports or stiles 11 and 12 between which extend rungs 20 at spaced intervals along their lengths. Typically there will be 80 rungs spaced at 30 cm intervals giving a ladder 10 with a length of around 25 m.

The stiles 11 and 12 are each comprised by a length of synthetic fibre webbing having a width of about 2 cm.

The rungs 20 are each comprised by a length of about 15 cm of carbon fibre rod 21 of about 1 cm diameter enclosed in a tubular sheath 22 of synthetic fibre braid.

The ends of the lengths of rod 21 are rounded-off to prevent damage to the surrounding sheath.

The sheath 22 of each rung 20 has a length of about 22 cm leaving some 3.5 cm at each end beyond the ends of the enclosed rod 21. These extending ends are turned upwardly and secured to the stiles 11 and 12 by stitching.

At the upper end of the ladder are sewn eyes 30 to enable the ladder to be suspended from a suitable support by any suitable intermediate means.

Preferred synthetic fibres for the components of the ladder include Kevlar (RTM), Nomex (RTM) (a fire resistant fibre) polypropylene, nylon and polyester.

It will be appreciated that it is not intended to limit the invention to the above example only, many variations, such as might readily occur to one skilled in the art, being possible, without departing from the scope thereof.

I claim:

1. A ladder comprising side supports or stiles of flexible textile material and spaced rung members enclosed in tubular sleeves whose opposed ends are secured to the stiles independently of the rung members.

2. A ladder according to claim 1 wherein the stiles are of synthetic fibre webbing.

3. A ladder according to claim 1 wherein the stiles have a width of about 2 cm.

4. A ladder according to claim 1 wherein the rung members are lengths of composite material.

5. A ladder according to claim 1 wherein the rung members are lengths of carbon fibre rod or tube.

6. A ladder according to claim 1 wherein the rung members are lengths of glass fibre rod or tube.

7. A ladder according to claim 1 wherein the rung members have a diameter in the range of from 8 mm to 2 cm and a length in the range of from 5 cm to 20 cm.

8. A ladder according to claim 1 wherein the tubular sleeve is a braid of synthetic fibre.

9. A ladder according to claim 1 wherein the length of each sleeve is such as to leave 3.5 to 5 cm at each end for attachment to the stiles.

10. A ladder according to claim 1 wherein the ends of each tubular sheath is secured to the stiles by sewing.

11. A ladder comprising side supports or stiles of flexible textile material and spaced rung members enclosed in tubular sleeves whose opposed ends extend beyond the rung members and are secured to the stiles.

12. A method of making a ladder comprising providing two lengths of flexible textile material which are to form the stiles of the ladder, providing a plurality of sleeves each enclosing a rung member in such a way that the ends of the sleeves project beyond the rung members, and connecting the rung members between the stiles in spaced relation to each other by securing the ends of the sleeves to the stiles.
